(19) United States
(12) Patent Application Publication
(10) Pub. No.: US 2020/0242776 A1
(43) Pub. Date: Jul. 30, 2020

(54) MEDICAL IMAGE PROCESSING APPARATUS, MEDICAL IMAGE PROCESSING METHOD, AND SYSTEM

(71) Applicant: ZIOSOFT, INC., Tokyo (JP)

(72) Inventors: Tsuyoshi NAGATA, Tokyo (JP); Yuichiro HOURAI, Tokyo (JP); Yusuke INOUE, Tokyo (JP)

(21) Appl. No.: 16/775,379

(22) Filed: Jan. 29, 2020

(30) Foreign Application Priority Data
Jan. 29, 2019 (JP) 2019-013564

(51) Int. Cl. G06T 7/12

(52) U.S. Cl. CPC G06T 7/12; G06T 2207/30101; G06T 2207/10081; G06T 2207/30061

(57) ABSTRACT

A medical image processing apparatus includes: a memory; and a processor configured to execute a process. The process includes: acquiring volume data including one or more organs; and performing processing relating to segment division of the one or more organs. The performing includes: acquiring a first tree structure included in the one or more organs; acquiring a second tree structure included in the one or more organs; and generating a plurality of first segments obtained by dividing the one or more organs based on the first tree structure and the second tree structure. At least a part of a branch of the first tree structure passes through a central portion of the plurality of first segments, and at least a part of a branch of the second tree structure passes along a boundary between the plurality of first segments.

### CROSS-REFERENCE TO RELATED APPLICATIONS

This application is based on and claims priority under 35 USC 119 from Japanese Patent Application No. 2019-013564 filed on Jan. 29, 2019, the contents of which are incorporated herein by reference.

### TECHNICAL FIELD

The present disclosure relates to a medical image processing apparatus, a medical image processing method, and a system.

### BACKGROUND

In the related art, it is known that a lung is divided into segments based on a bronchial structure in the lung (refer to U.S. Patent Application Publication No. 2014/0079306). It is disclosed in Japanese Unexamined Patent Application, First Publication No. 2014-73355 that a three-dimensional medical image of the thorax is acquired, a bronchial structure is extracted from the three-dimensional medical image, the bronchial structure is divided based on a junction of the bronchial structure, and a plurality of divided lung regions are acquired based on the plurality of divided bronchial structures.

### SUMMARY

In a case where a lung is divided into segments based on the bronchi, the accuracy of the division becomes low. Therefore, in some cases, the position of a boundary between segments is different from the position of an actual boundary.

The present disclosure has been made in consideration of the above-described circumstances and provides a medical image processing apparatus, a medical image processing method, and a system which can improve the accuracy of the segment division of an organ.

A medical image processing apparatus that performs segment division of an anatomical segments of one or more organs includes: a memory; and a processor configured to execute a process. The process includes: acquiring volume data including the one or more organs; and performing processing relating to segment division of the one or more organs. The performing includes: acquiring a first tree structure included in the one or more organs; acquiring a second tree structure included in the one or more organs; and generating a plurality of first segments obtained by dividing the one or more organs based on the first tree structure and the second tree structure. At least a part of a branch of the first tree structure passes through a central portion of the plurality of first segments, and at least a part of a branch of the second tree structure passes along a boundary between the plurality of first segments.

According to the present disclosure, it is possible to improve the accuracy of the segment division of an organ.

### BRIEF DESCRIPTION OF DRAWINGS

FIG. 1 is a block diagram illustrating a hardware configuration example of a medical image processing apparatus according to a first embodiment.

FIG. 2 is a block diagram illustrating a functional configuration example of the medical image processing apparatus.

FIG. 3A is a diagram illustrating a result of Voronoi tessellation of a comparative example.

FIG. 3B is a diagram in which the result of the Voronoi tessellation of the first embodiment is corrected.

FIG. 4 is a diagram illustrating an example of a range of a vein to be used for segment division.

FIG. 5 is a flowchart illustrating a first example of a segment division procedure.

FIG. 6A is a diagram illustrating the first example of the segment division procedure.

FIG. 6B is a diagram illustrating the first example of the segment division procedure.

FIG. 6C is a diagram illustrating the first example of the segment division procedure.

FIG. 7 is a flowchart illustrating a second example of a segment division procedure.

FIG. 8 is a diagram illustrating a correction example of the result of the Voronoi tessellation.

FIG. 9 is a flowchart illustrating an example of a processing procedure using a result of segment division in which a vein is added.

FIG. 10A is a diagram for illustrating segment division of the lung in the related art.

FIG. 10B is a diagram for illustrating segment division of the liver in the related art.

### DESCRIPTION OF EMBODIMENTS

Hereinafter, an embodiment of the present disclosure will be described with reference to the drawings.

A medical image processing apparatus that performs segment division of an anatomical segments of one or more organs includes: a memory; and a processor configured to execute a process. The process includes: acquiring volume data including the one or more organs; and performing processing relating to segment division of the one or more organs. The performing includes: acquiring a first tree structure included in the one or more organs; acquiring a second tree structure included in the one or more organs; and generating a plurality of first segments obtained by dividing the one or more organs based on the first tree structure and the second tree structure. At least a part of a branch of the first tree structure passes through a central portion of the plurality of first segments, and at least a part of a branch of the second tree structure passes along a boundary between the plurality of first segments.

Accordingly, the medical image processing apparatus can obtain segments close to segments of a clinical organ using the second tree structure. By positioning a segment to which the second tree structure belongs at a boundary without making the segment ambiguous, it is possible to improve the accuracy of segment division of an organ and to improve the accuracy of navigation during surgery or planning surgery. The user's uncomfortable feeling with respect to segment division is reduced.

Circumstances on How Aspect of Present Disclosure is Obtained

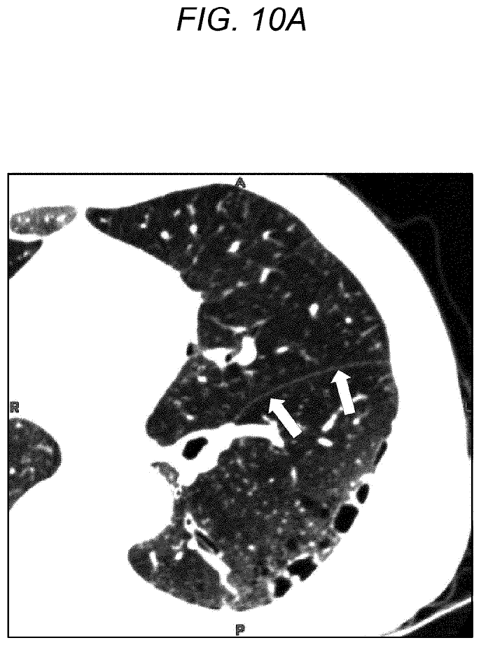

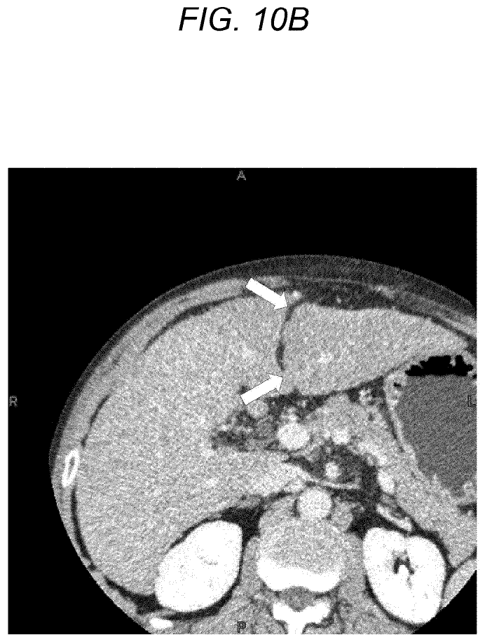

FIG. 10A is a diagram for illustrating segment division of the lung in the related art. The lung fissure (refer to distal portions of arrows) is reflected in an MPR image shown in FIG. 10A. The lung can be divided into a plurality of lobe based on the position of the fissure. FIG. 10B is a diagram for illustrating lobe division of the liver in the related art. The falciform ligament (refer to distal portions of arrows) is reflected in an MPR image shown in FIG. 10B. The liver can be divided into a plurality of lobes based on the position of the falciform ligament. However, it is difficult to perform segment division based on the lung fissure or the falciform ligament in a segment or sub-segment whose hierarchy is lower than that of the lobe. It is difficult to perform segment division based on the lung fissure or the falciform ligament for a patient whose lung fissure or falciform ligament are partially missing.

Segments of an organ (tissue) are formed around arteries or the portal vein so that the arteries or the portal vein nourish the organ. In a case of the lung, the bronchi and arteries develop together. Therefore, the bronchi tend to be positioned at the center of segments of the organ. Accordingly, an approximation of the segments is obtained if Voronoi tessellation is performed around the bronchi or the arteries.

A medical image processing apparatus, a medical image processing method, and a system which can improve the accuracy of segment division of an organ will be described in the following embodiment.

### First Embodiment

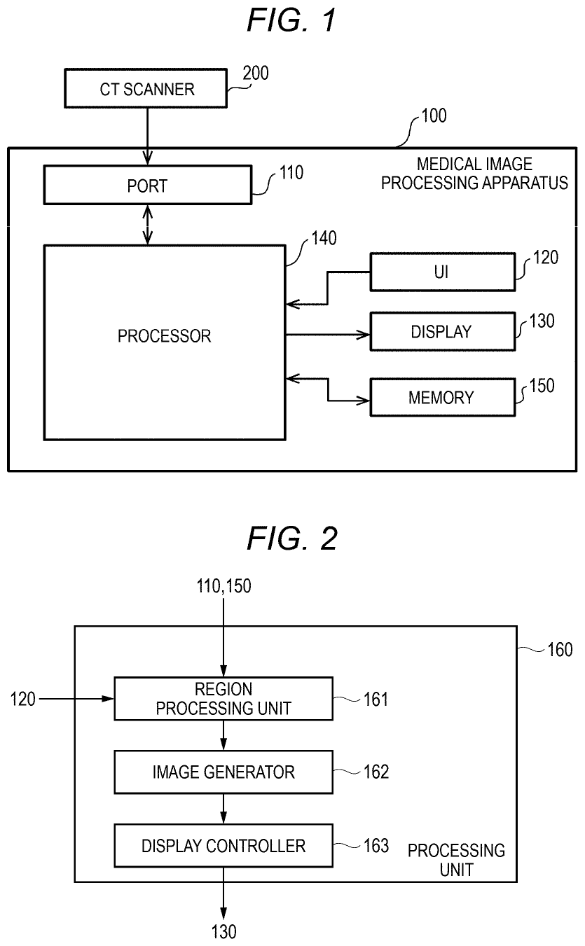

FIG. 1 is a block diagram illustrating a configuration example of a medical image processing apparatus 100 according to a first embodiment. The medical image processing apparatus 100 includes a port 110, a UI 120, a display 130, a processor 140, and a memory 150.

A CT scanner 200 is connected to the medical image processing apparatus 100. The medical image processing apparatus 100 obtains volume data from the CT scanner 200 and processes the acquired volume data. The medical image processing apparatus 100 may be constituted by a PC and software mounted on the PC.

The CT scanner 200 irradiates a subject with X-rays to capture an image (CT image) using a difference in absorption of X-rays due to tissues in the body. The subject may include a living body, a human body, an animal, and the like. The CT scanner 200 generates volume data including information on any portion inside the subject. The CT scanner 200 transmits the volume data as a CT image to the medical image processing apparatus 100 via a wire circuit or a wireless circuit. When capturing a CT image, imaging conditions relating to CT imaging or contrast conditions relating to administration of a contrast medium may be considered. The imaging may be performed on arteries or veins of an organ. The imaging may be performed a plurality of times at different timings depending on the characteristics of the organ.

The port 110 in the medical image processing apparatus 100 includes a communication port, an external device connection port, or a connection port to an embedded device and acquires volume data obtained from the CT image. The acquired volume data may be immediately sent to the processor 140 for various kinds of processing, or may be sent to the processor 140 as necessary after being stored in the memory 150. The volume data may be acquired via a recording medium or a recording media. The volume data may be acquired in the form of intermediate data, compressed data, or sinogram. The volume data may be acquired from information from a sensor device attached to the medical image processing apparatus 100. The port 110 functions as an acquisition unit that acquires various data such as volume data.

The UI 120 may include a touch panel, a pointing device, a keyboard, or a microphone. The UI 120 receives any input operation from a user of the medical image processing apparatus 100. The user may include a medical doctor, a radiology technician, a student, or other paramedic staffs.

The UI 120 receives various operations. For example, the UI receives operations such as designation of a region of interest (ROI) or setting of luminance conditions in volume data or an image based on the volume data (for example, a three-dimensional image or a two-dimensional image to be described below). The region of interest may include regions of various tissues (for example, blood vessels, the bronchi, organs, bones, the brain, and the heart). The tissues may include lesion tissue, normal tissue, tumor tissue, and the like.

The display 130 may include, for example, an LCD, and displays various pieces of information. Various pieces of information may include a three-dimensional image or a two-dimensional image obtained from volume data. The three-dimensional image may include a volume rendering image, a surface rendering image, a virtual endoscopic image, a virtual ultrasound image, a CPR image, and the like. The volume rendering image may include a ray-sum image, an MIP image, a MinIP image, an average value image, or a raycast image. The two-dimensional image may include an axial image, a sagittal image, a coronal image, an MPR image, and the like.

The memory 150 includes various primary storage devices such as ROM or RAM. The memory 150 may include a secondary storage device such as an HDD or an SSD. The memory 150 may include a tertiary storage device such as a USB memory or an SD card. The memory 150 stores various pieces of information and programs. The various pieces of information may include volume data acquired by the port 110, an image generated by the processor 140, setting information set by the processor 140, and various programs. The memory 150 is an example of a non-transitory recording medium in which programs are recorded.

The processor 140 may include a CPU, a DSP, or a GPU. The processor 140 functions as a processing unit 160 performing various kinds of processing and controls by executing a medical image processing program stored in the memory 150.

FIG. 2 is a block diagram illustrating a functional configuration example of the processing unit 160.

The processing unit 160 includes a region processing unit 161, an image generator 162, and a display controller 163. The processing unit 160 controls each portion of the medical image processing apparatus 100. Each portion included in the processing unit 160 may be realized as different functions using one hardware device or may be realized as different functions using a plurality of hardware devices. Each portion included in the processing unit 160 may be realized using exclusive hardware components.

The region processing unit 161 acquires volume data of a subject via the port 110, for example. The region processing unit 161 extracts any region contained in the volume data. The region processing unit 161 may extract a region of interest by automatically designating the region of interest based on pixel values of the volume data, for example. The region processing unit 161 may extract a region of interest by manually designating the region of interest via, for example, the UI 120. The region of interest may contain regions of the lung, the liver, the bronchi, the pulmonary arteries, the pulmonary veins, the portal vein, and the hepatic veins.

The region processing unit 161 may divide an organ of a subject by segments. The region processing unit 161 performs processing relating to this segment division. The segments may be roughly coincident with at least regions predefined clinically. The organ may contain the lung, the liver, and other organs. The segments may be at least some regions out of a combination of a plurality of segments. In a case where the organ is the lung, the segments may include sub-segments which are units in a finer range than that of the segments. The segments may include units (for example, sub-sub-segments) in a finer range than that of the sub-segments. The segment may include lobes.

The region processing unit 161 may divide an organ into a plurality of segments through Voronoi tessellation. In the Voronoi tessellation, the segment division may be performed based on a reference line or the distance between points on the line. The reference line may be a line representing a passage of tubular tissue such as blood vessels or the bronchi.

The region processing unit 161 may divide an organ into segments through Voronoi tessellation based on an extracted tree structure T1 (for example, the bronchi, arteries, and the portal vein) which easily passes through a central portion of a segment of an organ. The region processing unit 161 may correct a result of the Voronoi tessellation using a tree structure T2 (for example, veins and the lymphatic vessels) which easily passes through end portions or boundaries of segments. The region processing unit 161 may divide an organ into segments through Voronoi tessellation based on the extracted tree structure T1 and tree structure T2. The region processing unit 161 may correct a result of the Voronoi tessellation using the tree structure T2. The tree structures T1 and T2 may be tubular tissue.

The region processing unit 161 may calculate a region of the organ, to be excised, using the corrected result of Voronoi tessellation. The region to be excised is, for example, a region including a tumor for excising a tumor portion from an organ.

The image generator 162 generates various images. The image generator 162 generates a three-dimensional image or a two-dimensional image based on at least a part of acquired volume data (for example, volume data of extracted regions or segments). The display controller 163 displays various data, information, and images on the display 130. For example, a three-dimensional image or a two-dimensional image may be displayed. For example, a Voronoi tessellation result of an organ may be displayed by adding a vein.

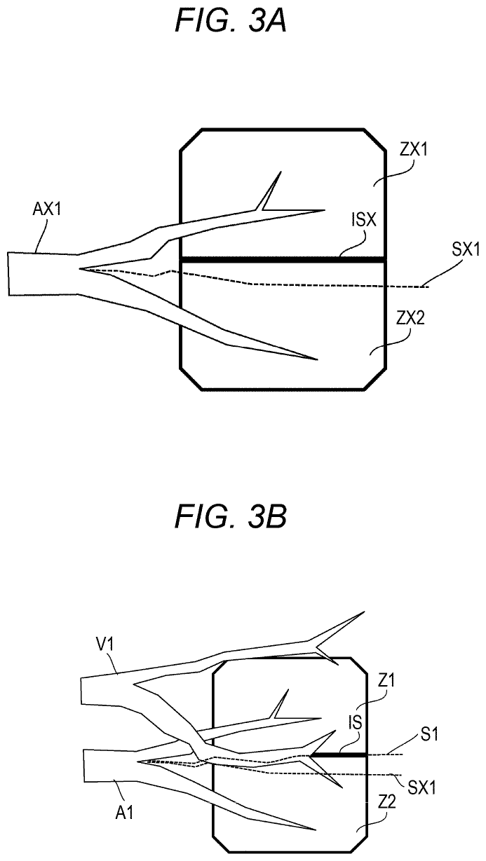

FIG. 3A is a diagram illustrating a result of Voronoi tessellation of a comparative example. In FIG. 3A, an organ is divided into segments ZX1 and ZX2 based on an artery AX1 as the tree structure T1. A division surface SX1 of the Voronoi tessellation enters the segments ZX2, and the division surface SX1 is not coincident with a boundary surface ISX between the anatomical segments ZX1 and ZX2 of the organ.

FIG. 3B is a diagram in which the result of the Voronoi tessellation is corrected by adding a vein V1 as the tree structure T2 of the present embodiment. An artery A1, the vein V1, and the like are shown in FIG. 3B. The division surface SX1 of the Voronoi tessellation is corrected and moved based on the vein V1 which easily passes through a boundary between anatomical segments Z1 and Z2. In FIG. 3B, correction is made such that a boundary surface IS between the anatomical segments Z1 and Z2 is disposed along the vein V1 and a division surface S1 is coincident with the boundary surface IS. The inventor uses this based on the findings that veins tend to pass along a space between adjacent segments of an organ.

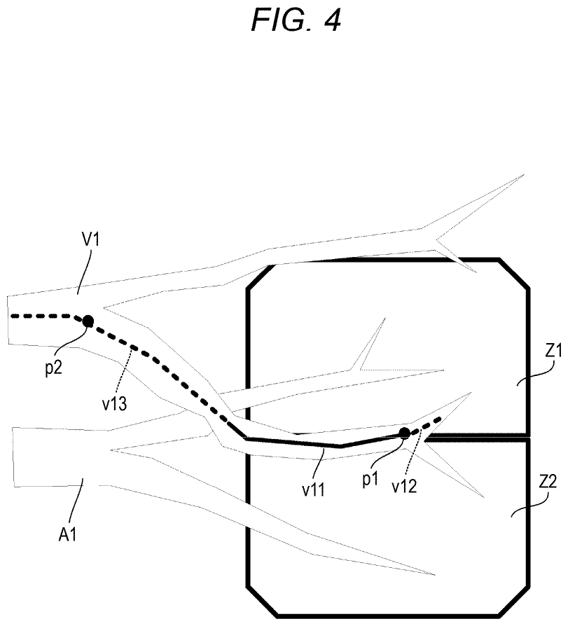

FIG. 4 is a diagram illustrating an example of a range of a vein as the tree structure T2 to be used for segment division. The UI 120 may receive an operation of selecting a branch of the vein V1 to be used for segment division. The selection may be selection of any point p1 of the branch of the vein V1 or may be selection of any range of the branch of the vein V1. In a case where the point p1 of the branch of the vein is selected via the UI 120, the region processing unit 161 may designate a range v11 of the vein to be used for segment division based on the selected point pl. For example, the range v11 of the vein may be designated based on the distance from the point p1 to a junction p2 on a root side of the branch. It may be previously determined how many branches (N-th branch) of the vein V1 are added for segment division to designate the range v11 of the vein based on the value of N. The range v11 of the vein may be designated based on the distance between the point p1 and the artery A1. In a case where a range of the vein is selected via the UI 120, the range may be designated as the range v11 of the vein to be used for segment division.

The region processing unit 161 may automatically and manually designate the range v11 of the vein using automatic and manual labeling results instead of designating the range v11 of the vein using the UI 120. Specific ranges of the bronchi, arteries, veins, and the like may be automatically designated using labeling results. The region processing unit 161 may estimate a range of branches of an artery (up to N-th branch) necessary for excision based on the size and the position of a tumor to designate the range v11 of the vein based on the estimation results. The region processing unit 161 may designate an artery Al to be used for segment division and designate a range of the artery. The range v11 of the vein may be designated by making the range of the artery with the range v11 of the vein.

A periphery v12 of the vein may not be included in the range v11 of the vein. Accordingly, it is possible to suppress all twigs on the peripheral side of the vein from being included in the range v11 of the vein and to improve the accuracy of segment division based on the range v11 of the vein. Since the peripheral side of the vein is included in an excision range during excision to which a tumor is added, strict division is not required in the range on the peripheral side of the vein. A root v13 of the vein may also not be included in the range v11 of the vein. Accordingly, it is possible to suppress designation of branches other than the branch of the vein to be subjected to segment division as the range v11 of the vein.

Next, an operation example of the medical image processing apparatus 100 will be described.

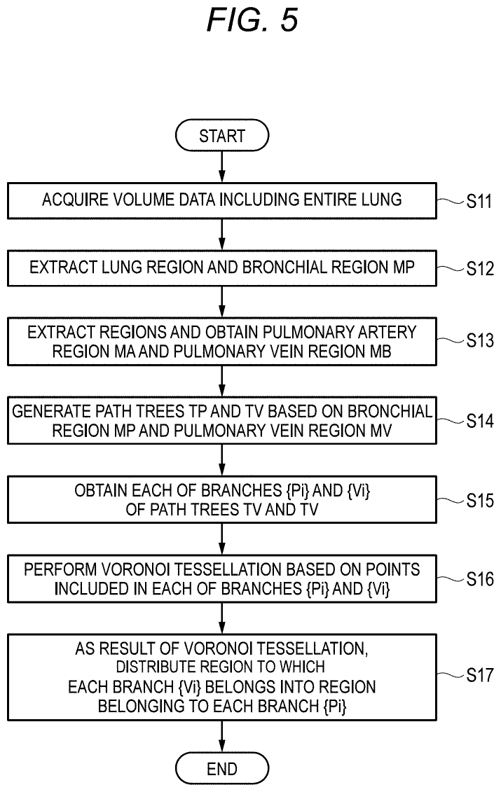

FIG. 5 is a flowchart illustrating a first example of a segment division procedure. Here, the bronchus is exemplified as the tree structure T1. However, the tree structure may be a pulmonary artery. The processing in FIG. 5 is mainly performed by the region processing unit 161.

First, volume data including the entire lung is acquired (S11). A region of the entire lung and a region (bronchial region MP) of a bronchus are extracted from the volume data (S12). A region (pulmonary artery region MA) of a pulmonary artery and a region (pulmonary vein region MV) of a pulmonary vein are extracted from the volume data (S13). In this case, a pulmonary arteriovenous separation algorithm may be executed. A bronchial path tree TP including the periphery of the bronchial region MP is generated based on the extracted bronchial region MP (S14). A pulmonary vein path tree TV including the periphery of the pulmonary vein region MV is generated based on the extracted pulmonary vein region MV (S14).

Each branch {Pi|i is an identification number of a bronchial branch} of the bronchial region MP included in the path tree TP is obtained (S15). Each branch {Vi|i is an identification number of a pulmonary vein branch} of the pulmonary vein region MV included in the path tree TV is obtained (S15). Voronoi tessellation is performed based on points included in {Pi}∪{Vi} (S16).

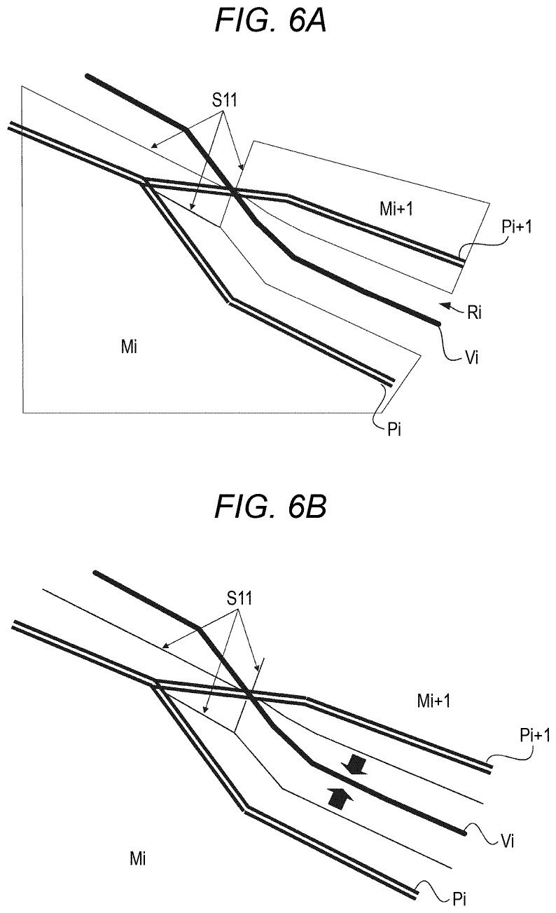

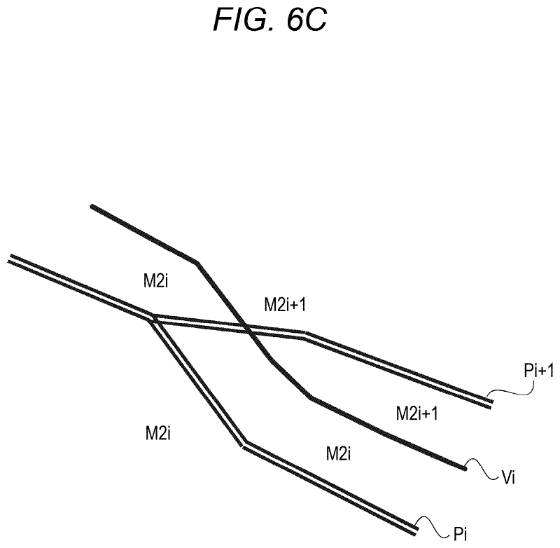

As a result of the Voronoi tessellation, each division region {a region in the vicinity of where i is an identification number of a division region} to which each branch {Pi} of the bronchial region MP belongs is formed (refer to FIG. 6A). A region other than each division region {Mi} in the entire lung region is each remaining region {Ri|i is an identification number of a remaining region} to which each branch {Vi} of the pulmonary vein region MV belongs. The region of {Mi} is expanded to {Ri}, for example, through fast marching to generate each expanded division region {M2i} (refer to FIGS. 6B and 6C). In this case, the marching speed of a predetermined point of {Mi} may be proportional to the distance between the predetermined point of {Mi} and {Vi} closest to this point. Accordingly, points included in {Ri} also belong to any of {M2i}. Each branch {Vi} of the pulmonary vein region MV mostly travels at boundaries between the expanded division regions {M2i}. In this manner, each remaining region {Ri} generated as a result of the Voronoi tessellation in S16 is distributed based on each branch {Vi} of the pulmonary vein region MV (S17).

FIGS. 6A to 6C are diagrams illustrating an example of distribution as a result of the Voronoi tessellation. In FIG. 6A, as a result of the Voronoi tessellation, the branch Pi of the bronchial region MP belongs to the division region Mi. A branch Pi+1 of the bronchial region MP belongs to a division region Mi+1. The branch Vi of the pulmonary vein region MV belongs to the remaining region Ri. Division surfaces S11 obtained as a result of the Voronoi tessellation are positioned at boundaries between regions such as the division regions Mi and Mi+1 and the remaining region Ri.

FIG. 6B shows a state in which the division regions Mi and Mi+1 are eroded toward the remaining region Ri, which exists between the division regions Mi and Mi+1 and to which the branch Vi of the pulmonary vein region MV belongs, and are expanded from the state of FIG. 6A showing the result of the Voronoi tessellation. In this case, the speed at which the division regions Mi and Mi+1 are expanded becomes slower as the division regions Mi and Mi+1 which are being expanded approach the branch Vi of the pulmonary vein region MV. The slow extension speed makes the distance between the branch Vi of the pulmonary vein region MV and the division regions Mi and Mi+1 become falsely far. That is, the vicinity of the pulmonary vein region MV is weighted.

FIG. 6C shows a formation of the expanded division region M2i corresponding to the expansion result of the division region Mi and an expanded division region M2i+1 corresponding to an expansion result of the division region Mi+1 while having the branch Vi of the pulmonary vein region MV as a boundary as a result of the extension of the division regions Mi and Mi+1 toward the branch Vi of the pulmonary vein region MV belonging to the remaining region Ri.

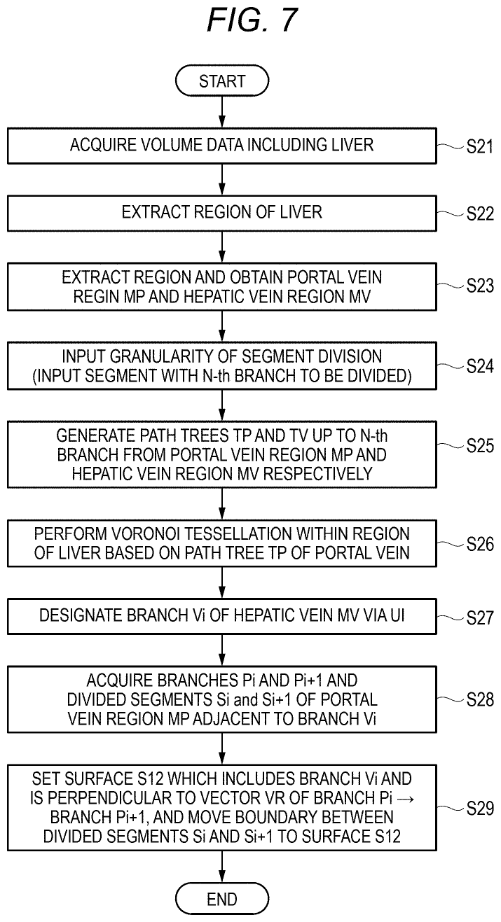

FIG. 7 is a flowchart illustrating a second example of a segment division procedure. The processing in FIG. 7 is mainly performed by the region processing unit 161.

First, volume data including the liver is acquired (S21). A region of the liver is extracted from the volume data (S22). A region (portal vein region MP) of a portal vein and a region (hepatic vein region MV) of a hepatic vein are extracted from the region of the liver (S23). The granularity (layer) for segment division is designated (S24). The granularity for segment division may indicate segment division will be performed up to which segment (the N-th branch) of the portal vein and the hepatic vein. In this case, an input of the granularity for the segment division may be received via the UI 120. A path tree TP of the portal vein including branches up to the N-th branch of the portal vein is generated with the designated granularity based on the extracted portal vein region MP (S25). A path tree TV of the hepatic vein including branches up to the N-th branch of the pulmonary vein is generated with the designated granularity based on the extracted hepatic vein region MV (S25).

Voronoi tessellation is performed on the liver based on the path tree TP of the portal vein (S26). Each division segment {Si|i is an identification number of a portal vein branch} is obtained through the Voronoi tessellation. Designation of a branch Vi of the hepatic vein is received via the UI 120, and operation information at this time is acquired (S27).

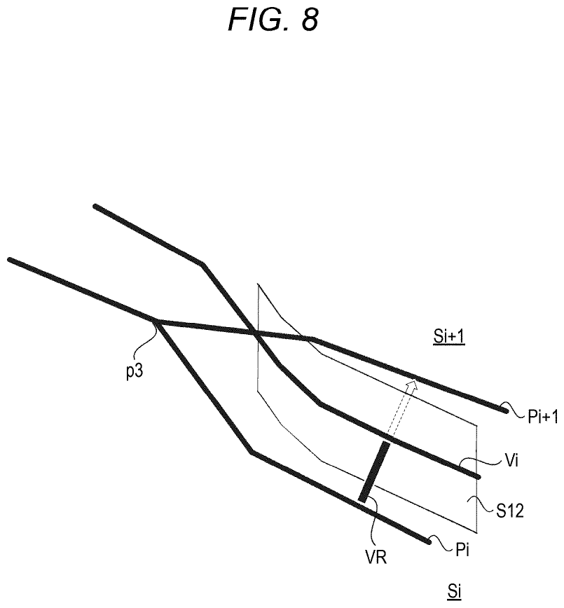

Branches Pi and Pi+1 of the portal vein adjacent to the branch Vi of the hepatic vein and division segments Si and Si+1 to which the branches Pi and Pi+1 of the portal vein respectively belong are acquired (S28). A surface S12 which includes points on the branch Vi of the hepatic vein and is perpendicular to a vector VR from the branch Pi toward the branch Pi+1 of the portal vein is set (refer to FIG. 8). A boundary between the division segments Si and Si+1 is moved to the surface S12 (S29). Accordingly, the division surface of the Voronoi tessellation is moved to the surface S12, and the position of the branch of the hepatic vein becomes the boundary between the division segments Si and Si+1.

FIG. 8 is a correction example of the result of the Voronoi tessellation.

The region processing unit 161 sets the surface S12 perpendicularly to the vector VR regarding the points on the branch Vi of the hepatic vein. The points on the branch Vi may be all of the points on the branch Vi, or may be points on the branch Vi within a range surrounded by the branches Pi and Pi+1 of the portal vein and a junction p3 of the branches Pi and Pi+1 as shown in FIG. 8. The direction of the vector VR may not be strictly the direction of the vector from the branch Pi toward the branch Pi+1. For example, the direction of the vector VR may be a direction of a vector from a distal end (an end portion of Pi opposite to the junction p3) of the branch Pi toward a distal end (an end portion of Pi+1 opposite to the junction p3) of the branch Pi+1. The direction of the vector VR may be a direction of vectors connecting points equidistant from the junction p3 of the branches Pi and Pi+1. The direction of each vector VR which passes through each point on the branch Vi may be the same as or different from each other depending on the position of each point on the branch Vi. The region processing unit 161 may extrapolate a previous path from the distal end of the branch Vi. The branch Pi+1 of the portal vein region MP and the branch Vi of the hepatic vein region MV intersect with each other in FIG. 8, but may not intersect with each other on a three-dimensional space.

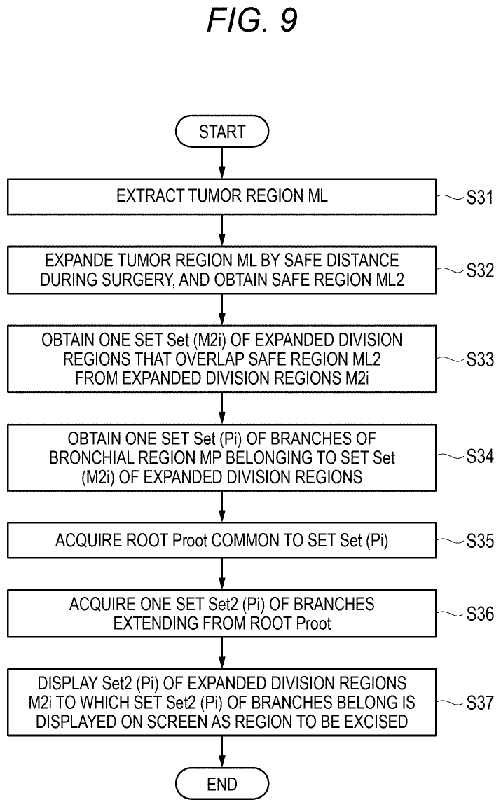

FIG. 9 is a flowchart illustrating an example of use of a result of segment division in which a vein is added. For example, the processing in FIG. 9 may be used for a preoperative simulation of segmentectomy for removing a lung tumor, or may be performed after S17 of FIG. 5. The processing in FIG. 9 may be applied as a preoperative simulation of segmentectomy for removing a liver tumor, or may be performed appropriately after S29 of FIG. 7 while replacing a subject with the liver, the portal vein, or the like. The processing in FIG. 9 is mainly performed by the region processing unit 161.

First, a region of a tumor (tumor region ML) is extracted from the entire lung region (S31). The tumor region ML is expanded outward by a safe distance during surgery, and a safe region ML2 is obtained (S32). A set Set (M2i) including one or more M2i's that overlap the ML2 region is extracted from each expanded division region {M2i} (S33). A set Set (Pi) of one or more branches Pi belonging to any of the set Set (M2i) of the expanded division regions is acquired from each branch ΣPi of the bronchi (S34). A root Proot (junction) of branches common to the set Set (Pi) of the bronchi is acquired (S35). A set Set2 (Pi) of branches Pi (on a more distal side than the root Proot) of the bronchi extending from the root Proot is acquired (S36). The set Set (M2i) of M2i's to which Set2 (Pi) belongs is set as a region to be excised (S37). The display 130 displays the region to be excised (S37). The display 130 displays a region other than the region to be excised. A user can compare the displayed regions.

In this manner, the medical image processing apparatus 100 can derive a region to be excised for excising a tumor using a segment division result in which veins are added. Accordingly, a user can grasp the shape of the region to be excised and the positional relationship between a blood vessel and a boundary surface between segments at a stage of planning surgery, which can be used as a guideline during surgery. A user can grasp the volume of an excision segment and a remaining segment at a stage of planning surgery, which can be used as a guideline during surgery. A user can minimize a region-to-be-excised of the lung which includes a tumor while considering a certain safe distance from the tumor. In an organ such as the lung or the liver which can be partitioned for each segment, it is possible to excise a part of the organ on a per segment basis when, for example, a tumor is found. At this time, a user can insert Kelly forceps and the like into a subject along a vein of an organ in consideration of the safe distance, and it becomes easy to excise a part of the organ.

Up to here, although various embodiments have been described with reference to the accompanying drawings, it is needless to say that the present disclosure is not limited to such examples. It would be apparent for those skilled in the art that various modification examples or corrected examples are conceivable within the scope recited in the claims, and it would be understood that these fall within the technical scope of the present disclosure.

In the above-described embodiment, various results for the Voronoi tessellation may be obtained depending on the definition of the distance. The distance here may include Euclidean distance, Manhattan distance, Chebyshev distance, and the like. For example, various distances may be used in discrete Voronoi tessellation for speeding up the calculation.

In the segment division in the above-described embodiment, the shape of the entire organ may be extracted to calculate the distance in the extracted region. In the segment division, boundary surfaces appearing on volume data of the falciform ligament, the mesenchyme, and the interlobular septum, and the like may be extracted in advance and used. In addition to the Voronoi tessellation, segment division may be performed using a distance map, or segment division may be performed using techniques, such as Snake and LevelSet, which are subtypes of various kinds of Voronoi tessellation and in which boundary surfaces unnecessarily appear on the volume data.

In the above-described embodiment, it has been exemplified that a region is divided into a region belonging to a segment and a region in which it is not determined which segment the region belongs to through Voronoi tessellation, and then, the undetermined region is distributed into each segment. However, the present invention is not limited thereto. It has also been exemplified that boundaries of divided segments are corrected after Voronoi tessellation, but the present invention is not limited thereto. A division region having a boundary in the vicinity of a vein may be generated through Voronoi tessellation performed once. In a case where it is assumed that, for example, the organ is the lung, a branch Vi of the pulmonary vein passing between the branches Pi and Pi+1 adjacent to the path tree TP of the bronchi may be specified. A surface S13 which includes points on the branch Vi of the pulmonary vein and is perpendicular to a vector VR from the branch Pi toward the branch Pi+1 of the bronchi may be set (not shown). A metric space met which may advance while weighting the distance may be generated on the surface S13. That is, the metric space met is a space in which moving (expanding) points hardly advance (hardly expand) on the surface S13 and the distance becomes farther than the actual distance. The Voronoi tessellation may be performed based on the path tree TP of the bronchi using the metric space met within the entire lung region. The metric space met may be set which advances not only on the surface S13 but also in a range within a predetermined distance from the surface S13 while weighting the distance.

In the Voronoi tessellation, an assumed division region ZMi (not shown) to which the branch Pi belongs and an assumed division region ZMi+1 to which the branch Pi+1 belongs may be assumed by expanding the assumed division regions around points of the branch Pi of the bronchi. The Voronoi tessellation may be performed by slowing down the speed at which the assumed division regions ZMi and ZMi+1 are expanded as the assumed division regions ZMi and ZMi+1 which are being expanded approach the branch Vi of the pulmonary vein region MV. As a result of the Voronoi tessellation, division regions ZM2i and ZM2i+1 (not shown) respectively corresponding to the expanded division regions M2i and M2i+1 having the pulmonary vein region MV as a boundary can be generated without correcting the boundary surface.

In the above-described embodiment, the organ segment may exist over a plurality of organs. The region processing unit 161 may extract a tumor and calculate a distance between the surface of the tumor and boundary surfaces of segments to display the calculated distance as a safe distance. For example, it is possible to select excision of segments or sub-segments in consideration of the safe distance. It is possible to provide a support so as to select excision on a per segment basis or non-segment excision (excision performed regardless of segments, for example, wedge-shaped excision or partial excision).

In the above-described embodiment, the display controller 163 may display the volume of an organ, the segment volume, the volume of a region to be excised, the residual volume, and the like. The display controller 163 may display an excision proportion or a residual proportion based on a region of an organ and a region to be excised. The segment volume may be the volume of segments which have been subjected to segment division. The segment volume may be the volume of segments up to the designated N-th branch. The residual proportion may be a ratio of the volume of remaining segments, which have not been excised, to the volume of the entire organ. By calculating the segment volume or the residual proportion, it is possible to compare the segmentectomy with non-segment excision, and a user can examine a more suitable excision method. In this case, the region processing unit 161 may calculate the segment volume or the residual proportion in the case of the non-segment excision. By improving the accuracy of division of the segment division, the medical image processing apparatus 100 can accurately grasp the volume of a segment to be excised and can accurately recognize the degree of influence on the function of an organ after excision.

The excision of a tumor is exemplified in the above-described embodiment, but may be applied to a surgical method for excising a lesion portion other than a tumor. In this case, the safe distance may not be considered. In the above-described embodiment, the region processing unit 161 may use a combination of well-known segment division techniques (for example, a level set method or a snake method) in order to move (correct) a boundary surface that partitions segments. In the above-described embodiment, a path tree is generated from a region of tubular tissue, but may be directly generated from volume data through tracking processing.

In the above-described embodiment, it has been exemplified that the tree structure T1 is, for example, a bronchus or a portal vein and the tree structure T2 is, for example, a vein. However, the tree structure T1 may be an artery or a vein and the tree structure T2 may be an artery or a lymphatic vessel depending on organs. In this case, segments of the liver may be recognized with a vein as a boundary, or segments of the liver may be recognized with an artery as a boundary. Accordingly, this can be used when, for example, it is desired to preserve veins. The tree structure T1 may be generated from a pulmonary artery in the lung. The folded intestinal wall (an example of an organ) may be recognized using the intestinal wall or the lumen of the intestinal tract as the tree structure T1 or the tree structure T2. In this case, segments of the intestines may be recognized with a vein as a boundary, or segments of the intestines may be recognized with an artery as a boundary. Nerves that pass through may be used as the tree structure T1 or the tree structure T2.

In the above-described embodiment, volume data as a captured CT image which is transmitted from the CT scanner 200 to the medical image processing apparatus 100 is exemplified. Alternatively, the volume data may be stored by being transmitted to a server or the like (for example, image data server (PACS) (not shown)) on a network so as to be temporarily accumulated. In this case, the port 110 of the medical image processing apparatus 100 may acquire volume data from the server or the like when necessary via a wire circuit or a wireless circuit or may acquire volume data via any storage medium (not shown).

In the above-described embodiment, volume data as a captured CT image which is transmitted from the CT scanner 200 to the medical image processing apparatus 100 via the port 110 is exemplified. It is assumed that this also includes a case where the CT scanner 200 and the medical image processing apparatus 100 are substantially combined as one product. This also includes a case where the medical image processing apparatus 100 is treated as a console of the CT scanner 200.

It has been exemplified in the above-described embodiment that an image is captured by the CT scanner 200 to generate volume data including information on the inside of a subject. However, an image may be captured by other devices to generate volume data. Other devices include a magnetic resonance imaging (MRI) apparatus, a positron emission tomography (PET) device, an angiography device, or other modality devices. The PET device may be used in combination with other modality devices. An organ, a tumor, a tree structure T1, and a tree structure T2 may be respectively acquired from different modality devices.

In the above-described embodiment, it can be expressed as a medical image processing method in which an operation of the medical image processing apparatus 100 is defined. It can be expressed as a program for causing a computer to execute each step of the medical image processing method.

Outline of Above Embodiment

One aspect of the above-described embodiment is a medical image processing apparatus 100 that performs segment division of an anatomical segments of one or more organs and may include: an acquisition unit (for example, a port 110) having a function of acquiring volume data including the anatomical segments of the one or more organs; and a processing unit 160 (for example, a region processing unit 161) having a function of performing processing relating to segment division of the anatomical segments of the one or more organs. The processing unit 160 has a function of acquiring a first tree structure (for example, a tree structure T1) included in the anatomical segments of the one or more organs, has a function of acquiring a second tree structure (for example, a tree structure T2) included in the anatomical segments of the one or more organs, and has a function of generating a plurality of first segments (for example, an expanded division region M2, a division segment Si in which a surface is moved, and a division region ZM2) obtained by dividing the anatomical segments of the one or more organs based on the first tree structure and the second tree structure. The medical image processing apparatus may be a medical image processing apparatus in which at least a part of a branch of the first tree structure passes a central portion of the plurality of first segments, and at least a part of a branch of the second tree structure passes along a boundary between the plurality of first segments. The first segments at least may include anatomical segments, sub-segments, sub-sub-segments, lobes and segments that may over a plurality of organs.

Accordingly, the medical image processing apparatus 100 can obtain segments close to segments of a clinical organ using the second tree structure. By positioning a segment to which the second tree structure belongs at a boundary without making the segment ambiguous, it is possible to improve the accuracy of segment division of an organ and to improve the accuracy of navigation during surgery or planning surgery. The user's uncomfortable feeling with respect to segment division is reduced.

The processing unit 160 may have a function of dividing the anatomical segments of the one or more organs into a plurality of second segments (for example, division regions Mi) based on the first tree structure and the second tree structure. The processing unit 160 may have a function of generating the plurality of first segments (for example, expanded division regions M2) by distributing a segment (for example, a remaining region Ri) subordinate to the second tree structure among the plurality of second segments into segments (for example, division regions Mi) subordinate to the first tree structure by dividing the subordinate segment so that at least a part of the branch of the second tree structure passes along the boundary between the segments. The second segments at least may include anatomical segments, sub-segments, lobes, sub-sub-segments and segments that exist over a plurality of organs.

Accordingly, the medical image processing apparatus 100 can perform segment division (for example, Voronoi tessellation) in which the second tree structure (for example, a tree structure found in a pulmonary vein region MV) is added. As a result, a division surface of segment division, in which the second tree structure is added, is generated along the second tree structure and is taken closer to a boundary surface IS of anatomical segments compared to segment division in which only the first tree structure is used. Therefore, the accuracy of segment division improves.

The processing unit 160 may have a function of dividing the anatomical segments of the one or more organs into a plurality of third segments (for example, the division regions Si) based on at least the first tree structure. The processing unit 160 may have correct positions of boundary surfaces (for example, division surfaces) of the plurality of third segments based on the second tree structure to generate the plurality of first segments. The third segments at least may include anatomical segments, sub-segments, sub-sub-segments, lobes and segments that exist over a plurality of organs.

Accordingly, the medical image processing apparatus 100 can correct a result of segment division, in which the second tree structure (for example, a hepatic vein region MV) is not added, using the hepatic vein region MV. Accordingly, the correction is performed so that the division surfaces of the segment division in which the second tree structure is not added follow the hepatic vein region MV. Accordingly, the division surfaces of the segment division approach the boundary surfaces IS of the anatomical segments, and therefore, the accuracy of segment division improves.

The processing unit 160 may have a function of acquiring a first branch (for example, a branch Pi) and a second branch (for example, a branch Pi+1) adjacent to the first tree structure. The processing unit 160 may have a function of acquiring a third branch (for example, a Vi) of the second tree structure which is positioned between the first branch and the second branch. The processing unit 160 may have a function of weighting the vicinity of the third branch to divide the anatomical segments of the one or more organs into the first segments based on the first and second tree structures and the weighting.

Accordingly, the medical image processing apparatus 100 can improve the accuracy of division through segment division performed once by devising a metric space for Voronoi tessellation.

The processing unit 160 may have a function of acquiring operation information for designating at least a part of the second tree structure. The processing unit 160 may have a function of correcting positions of boundary surfaces IS of the plurality of third segments so that the above-described designated part is set as a boundary. The medical image processing apparatus 100 may include a display unit (for example, a display 130) that displays the plurality of first segments. The second tree structure may be a vein.

Accordingly, a user can designate a specific second tree structure using the UI 120 to correct the result of the segment division based on the second tree structure. The medical image processing apparatus 100 can determine a boundary between segments so that the designated second tree structure is positioned at the boundary between the desired segments even in a case where, for example, a region of the second tree structure is included in undesired segments. A user can check the display 130 to observe the state of the first segments. The medical image processing apparatus 100 can generate segments so that at least a part of a vein that tends to be ambiguous to which segment it belongs is positioned at a boundary between segments.

One aspect of the present embodiment may be a medical image processing method for performing segment division of an anatomical segments of one or more organs, the method including steps of: acquiring volume data including the anatomical segments of the one or more organs; acquiring a first tree structure included in the anatomical segments of the one or more organs, acquiring a second tree structure included in the anatomical segments of the one or more organs, and generating a plurality of first segments obtained by dividing the anatomical segments of the one or more organs based on the first tree structure and the second tree structure, in which at least a part of a branch of the first tree structure passes through a central portion of the plurality of first segments, and at least a part of a branch of the second tree structure passes along a boundary between the plurality of first segments.

One aspect of the present embodiment may be a medical image processing program for causing a computer to execute the above-described medical image processing method.

The present disclosure is useful for a medical image processing apparatus, a medical image processing method, and a medical image processing program which can improve the accuracy of segment division of an organ.

What is claimed is:

1. A medical image processing apparatus that performs segment division of anatomical segments of one or more organs, comprising:
a memory; and
a processor configured to execute a process, the process comprising:
acquiring volume data including the one or more organs; and
performing processing relating to segment division of the one or more organs, wherein
the performing comprises:
acquiring a first tree structure included in the one or more organs;
acquiring a second tree structure included in the one or more organs; and
generating a plurality of first segments obtained by dividing the one or more organs based on the first tree structure and the second tree structure,
at least a part of a branch of the first tree structure passes through a central portion of the plurality of first segments, and
at least a part of a branch of the second tree structure passes along a boundary between the plurality of first segments.

2. The medical image processing apparatus according to claim 1, wherein the performing comprises:
dividing the one or more organs into a plurality of second segments based on the first tree structure and the second tree structure; and
distributing a segment subordinate to the second tree structure among the plurality of second segments into segments subordinate to the first tree structure such that at least a part of the branch of the second tree structure passes along a boundary between segments, to generate the plurality of first segments.

3. The medical image processing apparatus according to claim 1, wherein the performing comprises:
dividing the one or more organs into a plurality of third segments based on at least the first tree structure; and
correcting positions of boundary surfaces of the plurality of third segments based on the second tree structure to generate the plurality of first segments.

4. The medical image processing apparatus according to claim 1, wherein the performing comprises:
acquiring a first branch and a second branch adjacent to the first tree structure;
acquiring a third branch of the second tree structure which is positioned between the first branch and the second branch;
weighting vicinity of the third branch; and
dividing the one or more organs into the first segments based on the first and second tree structures and the weighting.

5. The medical image processing apparatus according to claim 3, wherein the performing comprises:
acquiring operation information for designating at least a part of the second tree structure; and
correcting positions of boundary surfaces of the plurality of third segments such that the designated part is set as a boundary.

6. The medical image processing apparatus according to claim 1, further comprising displaying the plurality of first segments.

7. The medical image processing apparatus according to claim 1, wherein the second tree structure is a vein.

8. A medical image processing method for performing segment division of an anatomical segments of one or more organs, the medical image processing method comprising:
acquiring volume data including the one or more organs;
acquiring a first tree structure included in the one or more organs;
acquiring a second tree structure included in the one or more organs; and
generating a plurality of first segments obtained by dividing the one or more organs based on the first tree structure and the second tree structure, wherein
at least a part of a branch of the first tree structure passes through a central portion of the plurality of first segments, and
at least a part of a branch of the second tree structure passes along a boundary between the plurality of first segments.

9. A medical imaging system for performing segment division of an anatomical segments of one or more organs, the medical imaging system comprising:
a memory; and
a processor configured to execute a process, the process comprising:
acquiring volume data including the one or more organs; and
performing processing relating to segment division of the one or more organs, wherein
the performing comprises:
acquiring a first tree structure included in the one or more organs;
acquiring a second tree structure included in the one or more organs; and
generating a plurality of first segments obtained by dividing the one or more organs based on the first tree structure and the second tree structure,
at least a part of a branch of the first tree structure passes through a central portion of the plurality of first segments, and
at least a part of a branch of the second tree structure passes along a boundary between the plurality of first segments.
